(19) United States
(12) Patent Application Publication
(10) Pub. No.: US 2026/0284576 A1
(43) Pub. Date: Sep. 24, 2026

(54) METHOD FOR IMMOBILIZING CARBON DIOXIDE

(71) Applicant: HONDA MOTOR CO., LTD., Tokyo (JP)

(72) Inventor: Kohei TOMITA, Wako-shi (JP)

(21) Appl. No.: 19/537,945

(22) Filed: Feb. 12, 2026

(30) Foreign Application Priority Data
Mar. 24, 2025 (JP) 2025-048686

(51) Int. Cl. B01D 53/14; B01F 23/237; B01F 101/00

(52) U.S. Cl. CPC B01D 53/1412; B01D 53/1475; B01F 23/23762; B01D 2252/1035; B01D 2257/504; B01F 2101/305

(57) ABSTRACT

A method for immobilizing carbon dioxide according to the present disclosure includes an adjusting pH step of adjusting a pH value of a solvent, and a mixing step of mixing a gas containing carbon dioxide and a substance containing at least one of an alkali metal and an alkali earth metal with the solvent thus subjected to the pH adjustment. In the method according to the present disclosure, the pH value of the solvent is adjusted to 5.5 or less in the adjusting pH step. In the method according to the present disclosure, the pH value of the solvent is adjusted to 8 or more in the adjusting pH step.

### CROSS-REFERENCE TO RELATED APPLICATION

This disclosure claims the priority benefit of Japanese Patent Application No. 2025-048686 filed on Mar. 24, 2025, and the entirety of the above-mentioned patent application is hereby incorporated by reference herein and made a part of this specification.

### TECHNICAL FIELD

The present disclosure relates to a method for immobilizing carbon dioxide.

### BACKGROUND ART

One of negative emission techniques for removing carbon dioxide (CO₂) from the atmosphere includes a weathering acceleration technique using rock or the like. This weathering acceleration technique aims at removing a large amount of carbon dioxide by accelerating a weathering phenomenon in nature where rock carbonates carbon dioxide over a long period of time (i.e., on the order of thousands of years or tens of thousands of years).

Regarding the weathering acceleration technique, for example, US Patent Publication No. 11921098 (Patent Document 1) discloses a technique of performing weathering acceleration by disposing an aggregated silicate mineral having a mean particle size of 0.5 to 3 mm in the soil (refer to claims 1 and 9).

Further, US Patent Publication No. 11896930 (Patent Document 2) discloses a method for quantifying removal of carbonic acid by carbon removing sand (refer to claim 1), and cites an aquatic environment as a target environment where the carbon removing sand is disposed (refer to claims 4 and 8).

### SUMMARY OF THE DISCLOSURE

According to the weathering acceleration techniques disclosed in Patent Documents 1 and 2, when a large amount of carbon dioxide is to be removed, a large space (i.e., soil or aquatic environment) for disposing the prepared agglomerated silicate mineral or carbon removal sand is required. Further, since the weathering acceleration technique is a technique utilizing the weathering phenomenon in nature as described above, the technique usually requires a long period of time.

Therefore, in the weathering acceleration technique, “improvement of immobilization efficiency” of carbon dioxide (in other words, acceleration of a chemical reaction for immobilizing and removing carbon dioxide), which contributes to reduction of space and shortening of time, is a very important issue.

In view of the above, an object of the present disclosure is to provide a method capable of improving the immobilization efficiency of carbon dioxide.

In order to solve the above issue, a method for immobilizing carbon dioxide according to the present disclosure includes an adjusting pH step of adjusting a pH value of a solvent, and a mixing step of mixing a gas containing carbon dioxide and a substance containing at least one of an alkali metal and an alkali earth metal with the solvent of which pH value was adjusted.

According to the method for immobilizing carbon dioxide of the present disclosure, immobilization efficiency of carbon dioxide gas can be improved.

### BRIEF DESCRIPTION OF THE DRAWINGS

FIG. 1 is a schematic view of an immobilization apparatus for carrying out a method for immobilizing carbon dioxide according to the present embodiment.

FIG. 2 is a graph showing a relationship between a pH value of an acidic solvent and a CO₂ removing rate (i.e., an immobilized amount of carbon dioxide per unit weight of an immobilization substance in 1 hour).

FIG. 3 is a graph showing a relationship between a pH value of an alkaline solvent and a CO₂ removing rate (i.e., an immobilized amount of carbon dioxide per unit weight of an immobilization substance in 1 hour).

### DESCRIPTION OF EMBODIMENT

Hereinafter, an embodiment (i.e., present embodiment) for carrying out a method for immobilizing carbon dioxide according to the present disclosure will be described.

### [Method for Immobilizing Carbon Dioxide]

A method for immobilizing carbon dioxide according to the present embodiment includes an adjusting pH step and a mixing step. Here, the “method for immobilizing carbon dioxide” according to the present embodiment can be rephrased as a “method for removing carbon dioxide” because carbon dioxide is removed by immobilization. Further, the method can also be rephrased as a “weathering acceleration method” because the method is also a method for accelerating a weathering phenomenon in nature.

Hereinafter, the respective steps will be described more specifically.

### (Adjusting pH Step)

An adjusting pH step is a step of adjusting a pH value of the solvent before mixing a gas or a substance described later.

As a result of intensive studies on the weathering phenomenon, the present inventors have found that carbon dioxide is efficiently immobilized by adjusting a pH value of a solvent in advance. Here, the solvent serves as a reaction field for promoting the weathering phenomenon. Based on the results of many experiments, it was confirmed that immobilization efficiency of carbon dioxide was capable of being improved by adjusting the solvent to “acidic” or “alkaline”, not to neutral.

Specifically, the pH value of the solvent after the pH adjustment is preferably 5.5 or less, more preferably 5 or less, 4 or less, 3 or less, or 2.5 or less, in the case of an acidic region. Further, the pH value of the solvent after the pH adjustment is preferably 8 or more, more preferably 9 or more, 10 or more, 11 or more, 12 or more, or 12.5 or more, in the case of an alkaline region.

The pH value of the solvent can be measured by a commercially available pH meter.

### (Adjusting pH Step: Solvent)

A solvent to be adjusted in the adjusting pH step is not particularly limited, but examples thereof include water (e.g., tap water, pure water, distilled water, and the like), seawater, river water, lake water, industrial water, and the like. Here, at least one of these may be used.

when seawater is selected as a solvent, seawater, which occupies most of water resources on the earth, can be used as it is. Therefore, not only desalination treatment or the like is unnecessary, but also an immobilization effect of carbon dioxide can be further enhanced by magnesium ions (Mg²⁺), calcium ions (Ca²⁺), hydrogen carbonate ions (HCO₃⁻), sodium ions (Na⁺), potassium ions (K⁺), and the like contained in seawater.

### (Adjusting pH Step: Acid, Base)

An acid and a base for adjusting a pH value in the adjusting pH step are not particularly limited, but a strong acid and a strong base are preferable, for example, as follows:

Examples of the strong acid include hydrochloric acid (HCL), sulfuric acid (H₂SO₄), nitric acid (HNO₃), hydrobromic acid (HBr), hydroiodic acid (HI), chloric acid (HClO₃), perchloric acid (HClO₄), and the like. Among these, hydrochloric acid, sulfuric acid, and nitric acid are preferable. Examples of the strong base include sodium hydroxide (NaOH), potassium hydroxide (KOH), lithium hydroxide (LiOH), calcium hydroxide (Ca(OH)₂), strontium hydroxide (Sr(OH)₂), and barium hydroxide (Ba(OH)₂). Among these, sodium hydroxide and potassium hydroxide are preferable.

### (Mixing Step)

A mixing step is a step of mixing a gas containing carbon dioxide (appropriately referred to as a “target gas”) and a substance containing at least one of an alkali metal and an alkali earth metal (appropriately referred to as an “immobilization substance”) with a solvent after the pH adjustment.

Specifically, in the mixing step, first, (1) the target gas begins to be supplied to the solvent at a constant flow rate. Thereafter, (2) the state that the pH value of the solvent is stable is confirmed. Finally, (3) the immobilization substance is mixed with the solvent.

The pH value being stable in (2) specifically means that the pH value varies within a range of ±0.02 in 5 minutes. The target gas of (1) is supplied at a constant flow rate until the mixing step is completed.

### (Mixing Step: Target Gas)

The target gas supplied to the solvent in the mixing step is a gas containing carbon dioxide (CO₂). A content of carbon dioxide in the target gas is not particularly limited, and is, for example, 0.03 v/v % or more, 0.1 v/v % or more, 0.3 v/v % or more, or 0.4 v/v % or more, and 30 v/v % or less, 10 v/v % or less, 5 v/v % or less, or 1 v/v % or less.

The target gas is not particularly limited as long as it is a gas containing carbon dioxide, and examples thereof include exhaust gases discharged from various plants, internal combustion engines of automobiles, and the like. Appropriately, the target gas may be subjected to a concentration treatment of carbon dioxide, or the like.

### (Mixing Step: Immobilization Substance)

An immobilization substance (i.e., a substance for immobilizing carbon dioxide) to be charged into the solvent in the mixing step is a substance containing at least one component (appropriately referred to as a “specific component”) of Li, Na, K, Rb, Cs, and Fr that are alkali metals and Be, Mg, Ca, Sr, Ba, and Ra that are alkali earth metals. Among these, preferably the specific component contained in the immobilization substance is K, Na, Ca, or Mg.

A content (or a total amount) of the specific component in the immobilization substance is not particularly limited, and is, for example, 10 w/w % or more, 20 w/w % or more, 25 w/w % or more, and 50 w/w % or less, 40 w/w % or less, 35 w/w % or less.

The immobilization substance is not particularly limited as long as it is a substance containing a specific component, and examples thereof include various minerals, building materials, and waste materials. Examples of minerals include peridotite, basalt, gabbro, and serpentine.

### (Mixing Step: Chemical Reaction)

Chemical reactions occurring in the mixing step are as follows, for example, in the case where the immobilization substance contains Mg as a specific component (specifically, in the case of rock containing Mg in the form of Mg₂SiO₄).

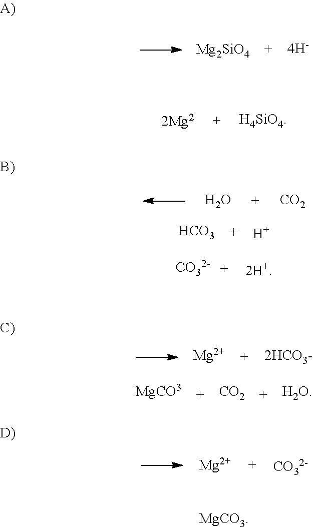

When the solvent is adjusted to “acidic” in the adjusting pH step, the chemical reaction of the above (A) proceeds due to an increase in the number of hydrogen ions (H⁺), and an amount of dissolved magnesium (i.e., an ionization amount) increases. As a result, the amount of magnesium ions (Mg²⁺) in the reaction field increases, and the chemical reactions (C) and (D) proceed, and finally, the amount of carbon dioxide thus immobilized as MgCO₃ increases.

On the other hand, when the solvent is adjusted to “alkaline” in the adjusting pH step, equilibrium in the chemical reaction (B) is shifted to the right due to an increase in an amount of hydroxide ions (OH⁻), and an ionization amount of carbon dioxide (i.e., an ionization amount of carbonic acid) increases. As a result, an amount of carbonate ions (HCO₃⁻, CO₃²⁻) in the reaction field increases, and the chemical reactions of (C) and (D) proceed, and finally, the amount of carbon dioxide thus immobilized as MgCO₃ increases.

### (Other Conditions: Target Gas and Immobilization Substance)

A supplied amount of the target gas to the solvent and a mixed amount of the immobilization substance are not particularly limited as long as carbon dioxide and the specific component are in a state of being neither too much nor too little, but are, for example, as follows.

When the supplied amount of carbon dioxide contained in the target gas is G (L/min) and the amount of the specific component contained in the immobilization substance is I (kg), G/I is, for example, 0.05 or more, 0.10 or more, or 0.13 or more, and 1.00 or less, 0.50 or less, or 0.20 or less.

### (Other Conditions: Solvent and Immobilization Substance)

An amount of the solvent is not particularly limited as long as the immobilization substance can be immersed therein, and is, for example, as follows.

When the amount of the solvent is S (L) and the amount of the immobilization substance is M (kg), S/M is, for example, 3 or more, 5 or more, or 8 or more, and 20 or less, 15 or less, or 10 or less.

### (Other Steps)

When a substance having a large size such as rock is used as the immobilization substance, a step of performing a pulverization treatment may be performed in advance.

The finer the immobilization substance is pulverized, the more the specific component is appropriately dissolved in the solvent, resulting in a preferable state.

A mean particle size of the immobilization substance is preferably 5 mm or less, more preferably 3 mm or less, and even more preferably 1 mm or less.

Note, the particle size of the immobilization substance can be measured by a laser diffraction-scattering method.

### (Effect of Method for Immobilizing Carbon Dioxide)

A method for immobilizing carbon dioxide according to the present embodiment includes an adjusting pH step of adjusting a pH value of a solvent, and a mixing step of mixing a gas containing carbon dioxide and a substance containing at least one of an alkali metal and an alkali earth metal with the solvent thus subjected to the pH adjustment.

According to the present embodiment, adjusting the pH value of the solvent in the adjusting pH step enables the chemical reaction between the target gas and the immobilization substance in the mixing step to be appropriately promoted. Thereby, immobilization efficiency of carbon dioxide can be improved.

In the method for immobilizing carbon dioxide according to the present embodiment, it is preferable that the pH value of the solvent is adjusted to 5.5 or less in the adjusting pH step. Further, in the method for immobilizing carbon dioxide according to the present embodiment, it is preferable that the pH value of the solvent is adjusted to 8 or more in the adjusting pH step.

According to the present embodiment, the pH value of the solvent is adjusted to acidic or alkaline in the adjusting pH step, and thus the effect of improving the immobilization efficiency of carbon dioxide is more strongly exerted.

In the method for immobilizing carbon dioxide according to the present embodiment, it is preferable that the mixing step includes mixing the substance with the solvent after the pH value of the solvent is stabilized, while supplying the gas to the solvent.

According to the present embodiment, the immobilization efficiency of carbon dioxide can be more reliably improved by specifying the operation order in the mixing step.

In the method for immobilizing carbon dioxide according to the present embodiment, the solvent is preferably at least one of water, seawater, river water, lake water, and industrial water.

According to the present embodiment, use of a predetermined solvent can appropriately exert the effect of improving the immobilization efficiency of carbon dioxide.

### [Immobilization Apparatus]

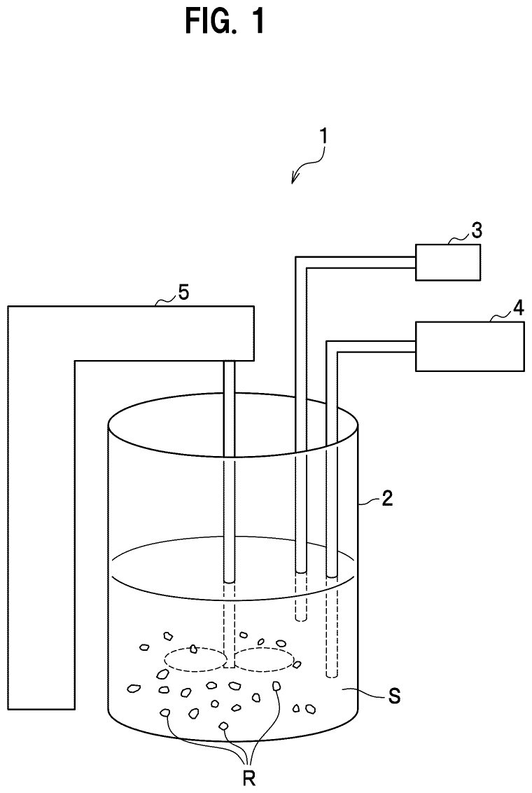

FIG. 1 is a schematic view of an immobilization apparatus for carrying out a method for immobilizing carbon dioxide according to the present embodiment.

An immobilization apparatus 1 includes a tank 2, an adjusting pH liquid supply means 3, a gas supply means 4, and a stirring means 5. In the immobilization apparatus 1, an adjusting pH liquid (i.e., acid, base) is supplied from the adjusting pH liquid supply means 3, and a target gas is supplied from the gas supply means 3 to a solvent S contained in the tank 2. Then, a pulverized substance R is charged into the tank 2, and materials inside the tank 2 are stirred by the stirring means 5. Details of the immobilization method using the immobilization apparatus 1 are as described in the “Method for Immobilizing Carbon Dioxide”.

In the method for immobilizing carbon dioxide according to the present embodiment, since the chemical reactions are completed in one reaction field, the immobilization apparatus 1 may have one tank 2. Therefore, for example, compared to the technique described in FIG. 1 of Japanese Patent No. 3954009, which requires two tanks, the present disclosure can save the space and simplify the equipment.

### EXAMPLES

Next, the present disclosure will be described by referring to Examples satisfying requirements of the present disclosure and Comparative Examples not satisfying the requirements of the present disclosure.

### [Experimental Procedure]

The procedure of the experiment is as follows.

(1) 800 mL of a solvent of which pH value was adjusted with an adjusting pH liquid so as to have the values shown in Table 1, was placed in a separable flask. An air stone for discharging a gas fed from an air pump described later as fine bubbles was placed on a bottom of the separable flask.

(2) A stirrer, a pH meter, an air pump, and an immobilization substance used in the experiment were prepared.

(3) The materials prepared in (1) and (2) above were placed in a globe box (i.e., internal volume: about 240 L), and a concentration of CO₂ inside the box was adjusted to 0.4% by CO₂ spray in a sealed state of the box.

(4) After the CO₂ concentration inside the box was stabilized at 0.4%, bubbling was started at a constant flow by an air pump, and a pH value of the solvent was measured every 5 minutes by a pH meter. Here, the air pump was a device that discharged gas inside the box as fine bubbles from below the solvent via an air stone.

(5) After the pH value was stabilized (i.e., after the fluctuation range of the pH values became within +0.02), the immobilization substance was added to the solvent, and stirring the solvent was started by the stirring device. Note, bubbling at a constant flow rate by the air pump was always performed.

(6) When an immobilized amount of carbon dioxide was saturated (i.e., a decrease in the CO₂ concentration inside the box stopped), the experiment was terminated.

Conditions of the materials used in the experiment are as follows.
Solvent: Water (distilled water)
adjusting pH liquid: Hydrochloric acid or sodium hydroxide
Immobilization substance: peridotite
Input amount of the immobilization substance: 0.1 kg
Mean particle size of the immobilization substance: 1 mm
Total rate of specific components in the immobilization
substances: about 30 w/w %
Stirrer: SS-PS1 manufactured by AS ONE Corporation
Stirring speed by stirrer: 500 rpm
PH meter: HM-40P manufactured by DKK-TOA Corporation
Air pump: Ei-10 manufactured by Kotobuki Craft
Air pump flow (max): 1.0 L/min
Air stone: manufactured by EINEY
CO₂ concentration measuring device: CO₂ Detector manufactured by Yudom Co., Ltd.
Experiment time: About 24 hours

### (Calculation of Immobilized Amount of Carbon Dioxide)

Based on the following calculation formulas, “The immobilized amount of the immobilization substance per unit weight in 1 hour” after initiation of the experiment was calculated.

[1] Immobilized amount of carbon dioxide in T hours: X

$$X ( g - {CO}_{2} ) = ( Δ {C}_{T} / 100 ) \times V \times D \qquad [ 1 ]$$

[2] Immobilized amount of carbon dioxide per unit weight of the immobilization substance: Y

$$Y ( g - {CO}_{2} / kg - rock ) = X / M \qquad [ 2 ]$$

[3] Immobilized amount of carbon dioxide per unit weight of the immobilization substance in 1 hour: Z

$$Z ( g - {CO}_{2} / kg - rock / hr ) = X / M / T \qquad [ 3 ]$$

In this test, a value of the CO₂ concentration inside the box at the time when one hour has elapsed from the initiation of the test (T=1) was used.

Note, symbols in the above formulas are as follows.

ΔC_{T}(%): amount of decrease in CO₂ concentration=initial CO₂ concentration (0.4%)−CO₂ concentration after T hours from the initiation of the test
V (m³): volume of the sealed glovebox
D (g/m³): Gas CO₂ density (1977 g/m³)
M (kg): weight of rock used in the experiment

It can be determined that the larger the value of “Z (g−CO₂/kg−rock/hr)” calculated by the above calculation formula is, the more excellent the “immobilization efficiency of carbon dioxide” becomes.

The following table shows a pH value and a type of solvent in the adjusting pH step of each sample. Further, the table shows results of an immobilized amount of carbon dioxide per unit weight of the immobilization substance in one hour (appropriately described as “CO₂ removing rate” in the table and the like). [Table 1]

### (Analysis of Results)

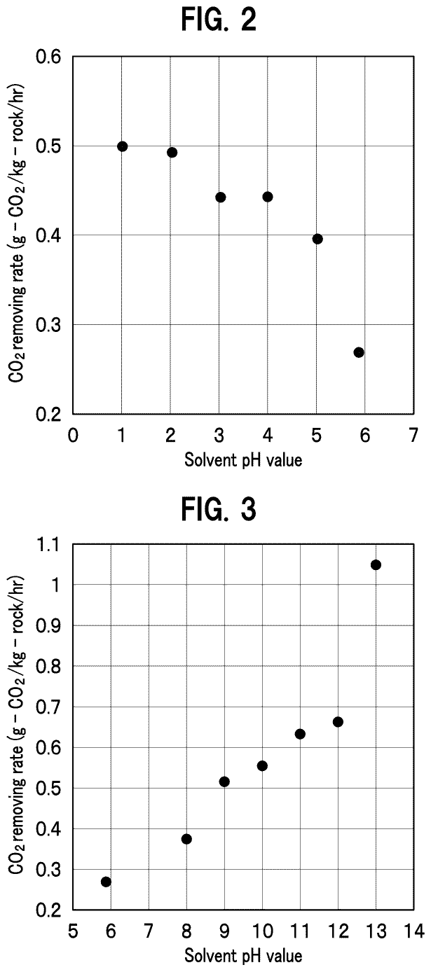

From the results of Samples 1 to 6 in Table 1 and FIG. 2, it was confirmed that the immobilization efficiency of carbon dioxide was significantly increased by adjusting the pH value of the solvent to “acidic” in the adjusting pH step.

Specifically, when Sample 6 which was in a neutral region was

| | Sample No. | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Type of | Hydrochloric acid aqueous | | | | | distilled | Sodium hydroxide aqueous | | | | | |
| Solvent | solution (distilled water base) | | | | | water | solution (distilled water base) | | | | | |
| pH Value | 1.02 | 2.04 | 3.04 | 4.00 | 5.02 | 5.87 | 8.02 | 9.02 | 10.02 | 11.14 | 12.03 | 13.00 |
| of Solvent | | | | | | | | | | | | |
| (—) | | | | | | | | | | | | |
| CO₂ | 0.50 | 0.49 | 0.44 | 0.44 | 0.40 | 0.27 | 0.38 | 0.52 | 0.55 | 0.63 | 0.66 | 1.05 |
| removing | | | | | | | | | | | | |
| rate (g- | | | | | | | | | | | | |
| CO₂/kg- | | | | | | | | | | | | |
| rock/hr) | | | | | | | | | | | | |

compared to Sample 5 which was adjusted to acidic, the result was that the “immobilized amount of carbon dioxide per unit weight of the immobilization substance in 1 hour” increased by about 1.5 times. As is clear from the results of Samples 1 to 5, it was found that the stronger the acidity is, the stronger the desired effect (i.e., the immobilization efficiency of carbon dioxide) is exerted.

From the results of Samples 6 to 12 in Table 1 and FIG. 3, it was confirmed that the immobilization efficiency of carbon dioxide was greatly increased by adjusting the pH value of the solvent to “alkaline” in the adjusting pH step.

Specifically, when Sample 6 which was in a neutral region was compared to Sample 8 which was adjusted to alkaline, the result was that the “immobilized amount of carbon dioxide per unit weight of the immobilization substance in 1 hour” increased by about two times. As is clear from the results of Samples 7 to 12, it was found that the stronger the alkalinity is, the stronger the desired effect (i.e., the immobilization efficiency of carbon dioxide) is exerted.

### REFERENCE SIGNS LIST

1 immobilization apparatus
2 tank
3 adjusting pH liquid supply means
4 gas supply means
5 stirring means
S solvent
R immobilization substance

What is claimed is:

1. A method for immobilizing carbon dioxide, including
an adjusting pH step of adjusting a pH value of a solvent;
a mixing step of mixing a gas containing carbon dioxide and a substance containing at least one of an alkali metal and an alkali earth metal with the solvent thus subjected to the pH adjustment.

2. The method for immobilizing carbon dioxide according to claim 1, wherein the pH value of the solvent is adjusted to 5.5 or less in the adjusting pH step.

3. The method for immobilizing carbon dioxide according to claim 1, wherein the pH value of the solvent is adjusted to 8 or more in the adjusting pH step.

4. The method for immobilizing carbon dioxide according to claim 1, wherein the mixing step includes mixing the substance with the solvent after the pH value of the solvent is stabilized while supplying the gas to the solvent.

5. The method for immobilizing carbon dioxide according to claim 2, wherein the mixing step includes mixing the substance with the solvent after the pH value of the solvent is stabilized while supplying the gas to the solvent.

6. The method for immobilizing carbon dioxide according to claim 3, wherein the mixing step includes mixing the substance with the solvent after the pH value of the solvent is stabilized while supplying the gas to the solvent.

7. The method for immobilizing carbon dioxide according to claim 1, wherein the solvent is at least one of water, seawater, river water, lake water, and industrial water.

8. The method for immobilizing carbon dioxide according to claim 2, wherein the solvent is at least one of water, seawater, river water, lake water, and industrial water.

9. The method for immobilizing carbon dioxide according to claim 3, wherein the solvent is at least one of water, seawater, river water, lake water, and industrial water.
